(19) United States
(12) Patent Application Publication
(10) Pub. No.: US 2016/0342604 A1
(43) Pub. Date: Nov. 24, 2016

(54) Apparatus and Method for Collaboratively Analyzing Data Snapshot Visualizations from Disparate Data Sources Using State Based Visual Data Link Recommendations

(71) Applicant: ClearStory Data Inc., Palo Alto, CA (US)

(72) Inventors: Stephen Edwin Link, Forest Park, IL (US); Bo Jonas Birger Lagerblad, Palo Alto, CA (US)

(73) Assignee: ClearStory Data Inc., Palo Alto, CA (US)

(21) Appl. No.: 15/225,589

(22) Filed: Aug. 1, 2016

Related U.S. Application Data
(63) Continuation-in-part of application No. 14/883,502, filed on Oct. 14, 2015.
Application No. 14/883,502 is a continuation-in-part of application No. 14/292,775, filed on May 30, 2014.
(60) Provisional application No. 61/829,191, filed on May 30, 2013.

(51) Int. Cl. G06F 17/30; G06T 11/20; G06F 3/0484; G06F 9/44

(52) U.S. Cl. CPC G06F 17/3056; G06F 9/4443; G06T 11/206; G06F 3/04847

(57) ABSTRACT

A server has a data processing module with instructions executed by a processor to maintain a collection of visualization frames that characterize a sequence of data analytics. Each visualization frame is a snapshot of data and the collection of visualization frames has associated permissions and visualization settings. A user navigation path through the collection of visualization frames is maintained. The navigation path specifies a data set used and a dimension accessed in the data set. A recommendation for a new visualization based upon the user navigation path is supplied. A new visualization selection is accepted and a new visualization is rendered based upon the new visualization selection.

### CROSS-REFERENCE TO RELATED APPLICATION

This application is a continuation-in-part of U.S. Ser. No. 14/883,502, filed Oct. 14, 2015, which is a continuation-in-part of U.S. Ser. No. 14/292,775, filed May 30, 2014, which claims priority to U.S. Provisional Patent Application Ser. No. 61/829,191, filed May 30, 2013.

This application is related to commonly owned U.S. Ser. No. 14/292,765, filed May 30, 2014, U.S. Ser. No. 14/292,783, filed May 30, 2014 and U.S. Ser. No. 14/292,788, filed May 30, 2014.

### FIELD OF THE INVENTION

This invention relates generally to data analyses in computer networks. More particularly, this invention relates to collaborative analyses of data snapshot visualizations from disparate sources.

### BACKGROUND OF THE INVENTION

Existing data analysis techniques typically entail discrete analyses of discrete data sources. That is, an individual typically analyzes a single data source in an effort to derive useful information. Individual data sources continue to proliferate. Public data includes such things as census data, financial data and weather data. There are also premium data sources, such as market intelligence data, social data, rating data, user data and advertising data. Other sources of data are private, such as transactional data, click stream data, and log files.

There is a need for a scalable approach to analyses of multiple sources of data. Ideally, such an approach would support collaboration between end users.

### SUMMARY OF THE INVENTION

A server has a data processing module with instructions executed by a processor to maintain a collection of visualization frames that characterize a sequence of data analytics. Each visualization frame is a snapshot of data and the collection of visualization frames has associated permissions and visualization settings. A user navigation path through the collection of visualization frames is maintained. The navigation path specifies a data set used and a dimension accessed in the data set. A recommendation for a new visualization based upon the user navigation path is supplied. A new visualization selection is accepted and a new visualization is rendered based upon the new visualization selection.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates component interactions utilized in accordance with an embodiment of the invention.

FIG. 3 illustrates processing operations associated with the data ingest module.

FIG. 4 illustrates a user interface for displaying inferred data types.

FIG. 5 illustrates a user interface to display join relevance indicia utilized in accordance with an embodiment of the invention.

FIG. 6 illustrates data merge operations performed in accordance with an embodiment of the invention.

FIG. 7 illustrates in-memory data units and corresponding discussion threads utilized in accordance with an embodiment of the invention.

FIG. 8 illustrates an initial graphical user interface that may be used in accordance with an embodiment of the invention.

FIG. 9 illustrates various data streams that may be evaluated by a user in accordance with an embodiment of the invention.

FIG. 10 illustrates data-aware convergence and visualization of disparate data sources.

FIG. 11 illustrates context-aware data analysis collaboration.

FIG. 12 illustrates data-aware visualization transition utilized in accordance with an embodiment of the invention.

FIG. 13 illustrates data-aware annotations utilized in accordance with an embodiment of the invention.

FIG. 14 illustrates context-aware annotations utilized in accordance with an embodiment of the invention.

FIG. 15 illustrates the construction of a storyboard from different stories in accordance with an embodiment of the invention.

FIG. 16 illustrates visualization units and discussion threads configured in accordance with an embodiment of the invention.

FIG. 17 illustrates data refresh prompts supplied in accordance with an embodiment of the invention.

FIG. 18 illustrates storyboard prompts and display features associated with embodiments of the invention.

FIG. 19 illustrates storyboard discussion threads utilized in accordance with embodiments of the invention.

FIG. 20 illustrates an embodiment of architectural components utilized to support storyboard operations disclosed herein.

Like reference numerals refer to corresponding parts throughout the several views of the drawings.

### DETAILED DESCRIPTION OF THE INVENTION

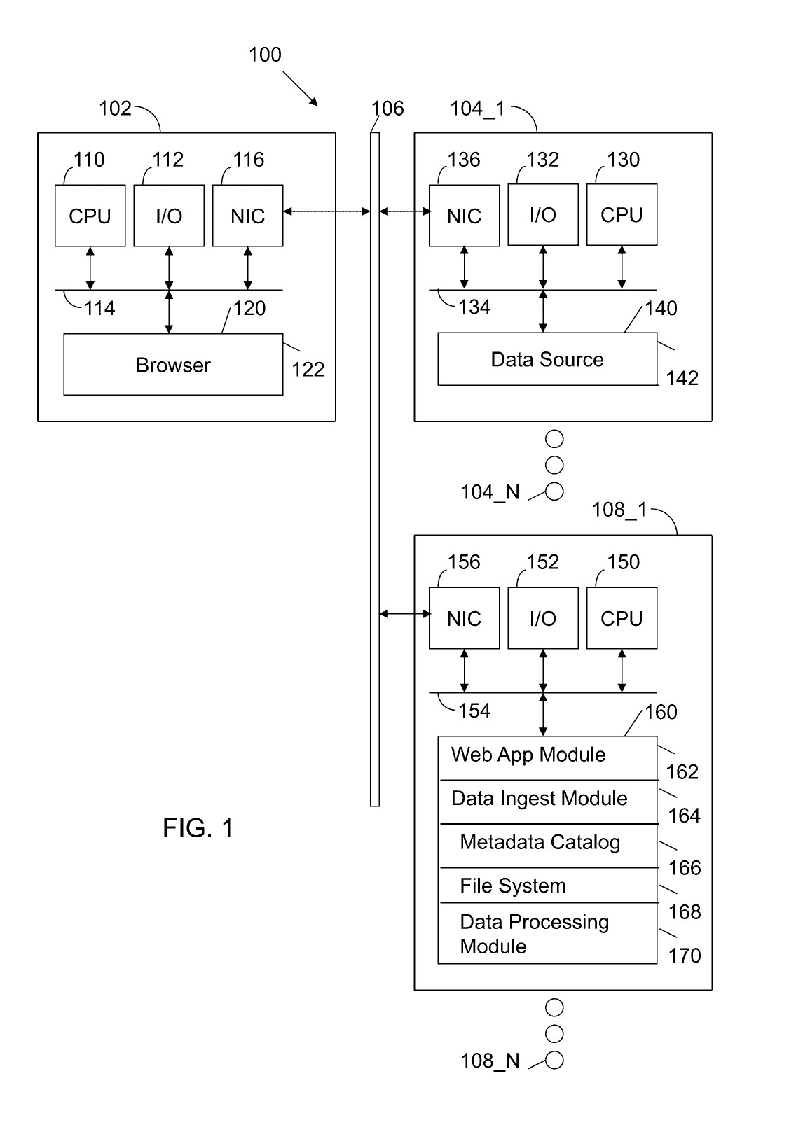

FIG. 1 illustrates a system 100 configured in accordance with an embodiment of the invention. The system 100 includes a client computer 102 connected to a set of servers 104_1 through 104_N via a network 106, which may be any wired or wireless network. The servers 104_1 through 104_N are operative as data sources. The figure also illustrates a cluster of servers 108_1 through 108_N connected to network 106. The cluster of servers is configured to implement operations of the invention.

The client computer 102 includes standard components, such as a central processing unit 110 and input/output devices 112 connected via a bus 114. The input/output devices 112 may include a keyboard, mouse, touch display and the like. A network interface circuit 116 is also connected to the bus 114 to provide an interface with network 106. A memory 120 is also connected to the bus 114. The memory 120 stores a browser 122. Thus, a client machine 102, which may be a personal computer, tablet or Smartphone, accesses network 106 to obtain information supplied in accordance with an embodiment of the invention.

Servers 104_1 through 104_N also include standard components, such as a central processing unit 130 and input/output devices 132 connected via a bus 134. A network interface circuit 132 is also connected to the bus 134 to provide connectivity to network 106. A memory 140 is also connected to the bus 134. The memory 140 stores a data source 142. Different servers 104 supply different data sources. For example, some servers may supply public data, such as census data, financial data and weather data. Other servers may provide premium data, such as market intelligence data, social data, rating data, user data and advertising data. Other servers may provide private data, such as transactional data, click stream data, and log files. The data may be in any form. In one form, the data is structured, such as data from a relational database. In another form the data is semi-structured, such as document-oriented database. In another form the data is unstructured. In still another form the data is streamed. A data stream is a sequence of data elements and associated real time indicators.

Each server 108 has standard components, such as a central processing unit 150 connected to input/output devices 152 via a bus 154. A network interface circuit 156 is also connected to the bus 154 to provide access to network 106. A memory 160 is also connected to the bus 154. The memory 160 stores modules and data to implement operations of the invention. In one embodiment, a web application module 162 is used to provide a relatively thin front end to the system. The web application module 162 operates as an interface between a browser 122 on a client machine 102 and the various modules in the software stack used to implement the invention. The web application module 162 uses application program interfaces (APIs) to communicate with the various modules in the software stack.

The memory 160 also stores a data ingest module 164. The data ingest module 164 consumes data from various data sources and discovers attributes of the data. The data ingest module 164 produces metadata characterizing ingested content, which is stored in a metadata catalog 166. The ingested data is loaded into a file system 168, as discussed below. A data processing module 170 includes executable instructions to support data queries and the ongoing push of information to a client device 102, as discussed below. The modules in memory 160 are exemplary. The different modules may be on each server in the cluster or individual modules may be on different servers in the cluster.

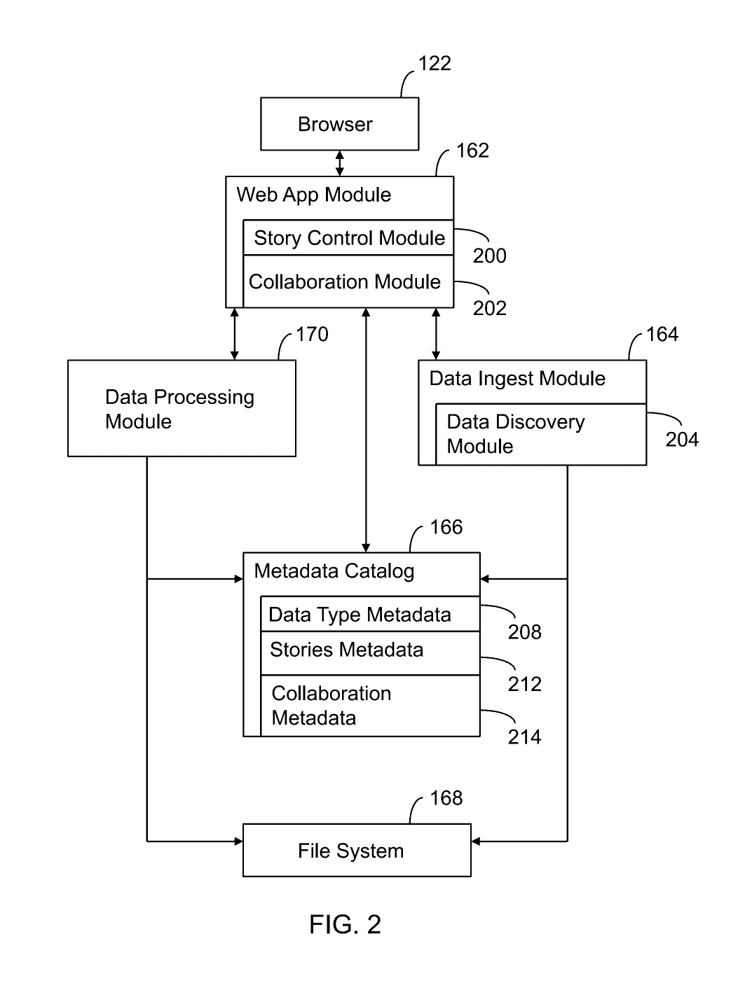

FIG. 2 is a more particular characterization of various modules shown in FIG. 1. The arrows in the figure illustrate interactions between the modules, which are achieved through APIs. At the top of the figure is a browser 122, which is resident on a client device 102. The remaining modules in the figure are implemented on a cluster of servers 108.

The web application module 160 may include a story control module 200. As used herein, the term story references an ongoing evaluation of data, typically from disparate sources. The data is pushed to a client device as data is updated. Thus, a data story is a living analysis of one or more data sets, which may be either internal or external data sources. A data story can be automatically refreshed on a set cycle to keep the analysis up-to-date as data from the source gets updated or refreshed.

The story control module 200 includes executable instructions to provide data visualizations that are data-aware. The data-awareness is used to appropriately scale data visualizations and harmonize data from discrete sources, as demonstrated below.

The web application module 160 may also include a collaboration module 202, which includes executable instructions to support collaboration between end users evaluating a common story. The collaboration module supports context-aware data analysis collaboration, such as data-aware visualization transitions, data-aware data annotations and context-aware data annotations, as demonstrated below.

FIG. 2 also illustrates a data ingest module 164, which includes a data discovery module 204. The data discovery module 204 includes executable instructions to evaluate attributes of ingested data. The data discovery module 204 communicates the attributes of the ingested data as data type metadata 208, which is stored in the metadata catalog 166.

In one embodiment, the data discovery module 204 operates in conjunction with a distributed, fault-tolerant real-time computation platform, such as the Storm open source software project. In one embodiment, the computation platform has a master node and worker nodes. The master node operates as a coordinator and job tracker. The master node assigns tasks to worker nodes and monitors for failures. Each worker node includes a supervisor method that listens for work assigned to it. Each worker node executes a subset of a topology. A running topology contains many worker processes spread across many machines.

A topology is a graph of a computation. Each node in a topology includes processing logic. Links between nodes indicate how data is passed between nodes. The computation platform may operate on a stream. A stream is an unbounded sequence of tuples. A tuple is an ordered list of elements. A field in a tuple can be an object of any type.

The computation platform provides the primitives for transforming a stream into a new stream in a distributed and reliable way. For example, one may transform a stream of tweets into a stream of trending topics. Stream transformations may be accomplished using spouts and bolts. Spouts and bolts have interfaces that one implements to run application-specific logic.

A spout is a source of streams. For example, a spout may read tuples and emit them as a stream. Alternately, a spout may connect to the Twitter API and emit a stream of tweets.

A bolt consumes any number of input streams, performs some processing and possibly emits new streams. Complex stream transformations require multiple steps and therefore multiple bolts. Edges in the graph indicate which bolts are subscribing to which streams. When a spout or bolt emits a tuple to a stream, it sends the tuple to every bolt that subscribed to that stream.

Links between nodes in a topology indicate how tuples should be passed. For example, if there is a link between Spout A and Bolt B, a link from Spout A to Bolt C, and a link from Bolt B to Bolt C, then every time Spout A emits a tuple, it will send the tuple to both Bolt B and Bolt C. All of Bolt B's output tuples will go to Bolt C as well.

Data type metadata 208 from the data ingest module 164 is loaded into a file system 168. In one embodiment, the file system 168 is a Hadoop Distributed File System (HDFS). Hadoop is an open-source software framework that supports data-intensive distributed applications. Alternately, the metadata may be stored in a separate catalog storage repository. Advantageously, HDFS supports the running of applications on large clusters of commodity hardware.

Returning to the metadata catalog 166, stories metadata 212 is maintained to support the story control module 200 of the web application module. The stories metadata 212 characterizes the type of data to be supplied in a story. The stories metadata 212 also includes state information to track changes in the story over time. Thus, the stories metadata 212 provides contextual information to reconstruct the development of a story over time.

The metadata catalog 166 also includes collaboration metadata 214. The collaboration metadata 214 supports operations performed by the collaboration module 202. The collaboration metadata 214 characterizes groups of individuals that may share a story. The collaboration metadata 214 may include various permissions that specify which individuals can see which data. For example, some collaborating individuals may have access to granular data, while others may only have access to aggregate data. The collaboration metadata 214 also maintains state information tracking collaboration over time. Consequently, the collaboration metadata 214 provides contextual information to reconstruct collaborative actions over time.

The collaboration metadata 214 may be used in connection with data and analytic data stories, concepts that will be discussed in detail below. Different permissions can be set for data versus stories. For example, some collaborating individuals may have the permission to add data to the system and manage the data. Some individuals may have access to granular data and others have access to aggregate data. For analytic data stories, collaborators may have permission to iterate a story, view it only or view and comment on it. All permissions on data and stories are maintained as state information tracked over time. Collaboration metadata permissions may specify what operations may be performed on data or the view of data. For example, in one embodiment, a read only collaborator may only comment on and view data.

In one embodiment, the data processing module 170 supports distributed in-memory processing of data. As discussed below, the data processing module 170 operates on data units utilized in accordance with an embodiment of the invention.

The data processing module 170 may utilize an open source cluster computing system, such as Spark from the University of California, Berkeley AMPLab. The core concept in Spark is a Resilient Distributed Dataset (RDD). An RDD is a data structure for a sequence of data that is fault tolerant and supports many parallel data manipulation operations, while allowing users to control in-memory caching and data placement.

RDDs explicitly remember the derivation trees for the data sets in memory so that they can be re-derived in case of a fault. RDDs also allow explicit caching so that important intermediate results can be held in memory, which accelerates later computations that require intermediate results or if that same result needs to be sent to a client again. The data processing module 170 is further discussed below. Attention initially focuses on data ingestion.

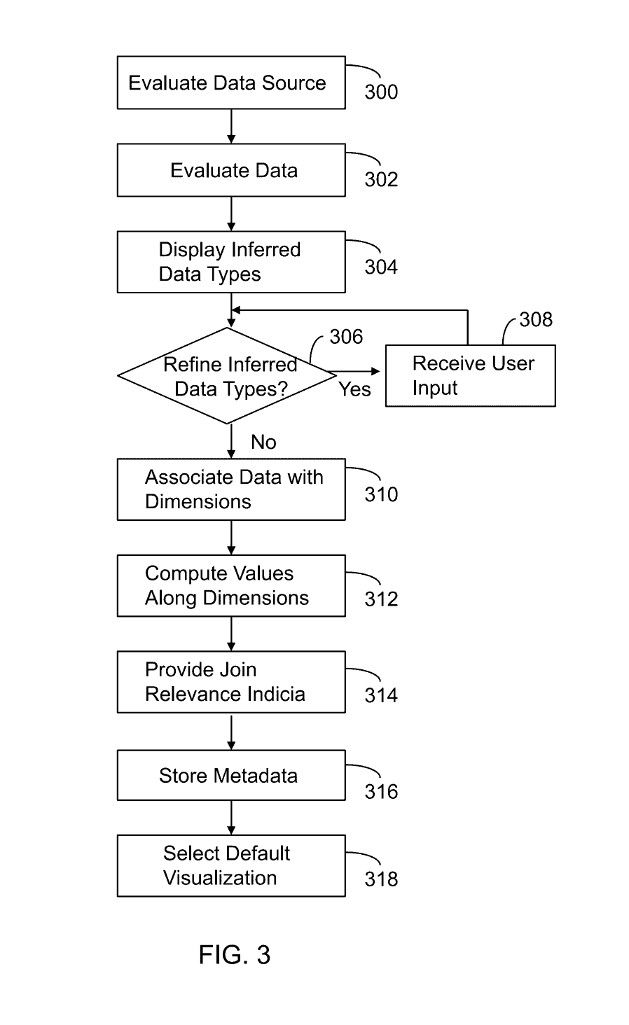

FIG. 3 illustrates processing operations associated with the data ingest module 164. Initially, the data ingest module 164 evaluates a data source 300. Based upon the data source, the module infers data types, data shape and/or data scale. The data types may be time data, geographical data, dollar amounts, streamed data, and the like. The data shape may be characterized in any number of ways, such as a continuous stream of uniform data, a continuous stream of bursty data, sparse data from a data repository, aggregated sections of data from a source, and the like. The data scale provides an indication of the volume of data being ingested from a data source. The data ingest module 164 processes all types of data, whether structured data (e.g., a relational database), semi-structured data (e.g., a document-oriented database) or unstructured data.

Next, the data is evaluated 302. That is, the actual data is processed to infer data types, data shape and/or data scale. In the case of data types, the identification of a zip code or geo-spatial coordinates implicates a geography data type. Alternately, certain number formats implicate a time data type. A currency indicator may implicate a sales data type. Categories are also supported as a data type. Categories may be any data which does not conform to time, geography or numeric types. For example, in the case of hotels, the categories may be business, resort, extended stay or bed and breakfast. Categories may be hierarchical, such as a reading material category with a hierarchy of electronic books, audible books, magazines and newspapers. The system detects category types and suggests them to the user. The system allows one to filter by a specific category value or break down a numeric measure by available category values (e.g., view Hotel Revenue split by different hotel categories). In the case of data shape, evaluation of the data may lend itself to characterizations of the shape of the data. In the case of the data scale, evaluation of the data provides an indication of the volume of data.

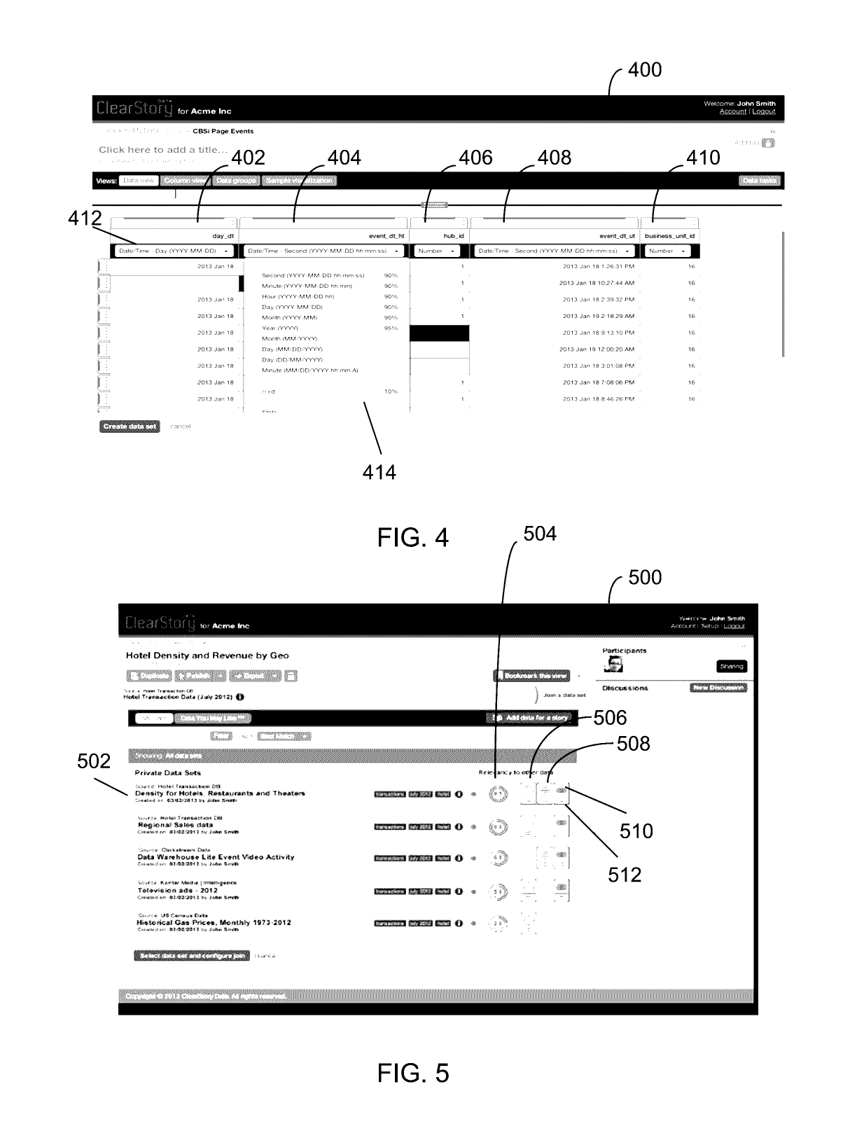

These evaluations result in inferred data types, which may be displayed to a user 304. FIG. 4 provides an example of such a display. In particular, FIG. 4 illustrates an interface 400 displaying an ingested csv file with five columns 402, 404, 406, 408 and 410. The first column 402 shows data in a Year/Month/Date format, which is indicated in data identification filed 412. The second column 404 has the same format. A user may access a window 414 showing the confidence of the characterization. The third column 406 is characterized as a number data type. The fourth column 408 has a Year/Month/Data format, while the fifth column 410 has an identified number data type. Thus, the system provides for user reinforcement, validation and correction of inferred data types.

Returning to FIG. 3, if a user wants to refine an inferred data she may do so (306—Yes). Input is then received from the user 308. For example, the window 414 of FIG. 4 may be used to receive user input that refines the data characterization. After data refinement or if data refinement is no longer required, the data is associated with one or more dimensions 310. A dimension is a hierarchical characterization of data. For example, in the case of a time dimension or a number dimension the hierarchy is increasing values. In the case of a geographical dimension the hierarchy is expanding geographical size (e.g., address to zip code to county to state to country).

Next, values are computed along dimensions 312. For example, consider the case of ingested data with a list of days. The days are aggregated into months, which are aggregated into individual years, which are aggregated into multiple years. This roll up of values is computed automatically. Thus, while an original data set may include data from individual days, the ingested data maintains the data from the individual days, but is also supplemented to include dimensional data of months, individual years and multiple years. Similarly, in the case of geography, if an original data set includes individual zip codes, those individual zip codes are augmented to include dimensional data for county, state and country, or any other default or specified hierarchy. Observe that this is performed automatically without any user input. Thus, the original data is pre-processed to include dimensional data to facilitate subsequent analyses. The original data may also be pre-processed to generate other types of metadata, such as the number of distinct values, a minimum value and maximum value and the like. This information may inform the selection of visualizations and filtering operations. This information may also be used to provide join relevance indicia 314.

FIG. 5 illustrates an interface 500 to provide join relevance indicia. In particular, the figure provides a textual description of a data set 502. Further, the interface provides indicia 504 of the relevance of the data to other data. In this case, the indicia include numeric indicia (9.5 on a scale of 10.0) and graphical indicia in the form of a 95% completed wheel. The indicia 504 may be accompanied by characterizations of the components of the data set. In this case, there is a chronological data type component 506, a geographical data type component 508 and an “other” data type component 510. Each data type component may include indicia 512 of confidence of the data type characterization. In one embodiment, the score is a function of the percentage of columns in the two data sets that can be merged. User input may be collected to revise or otherwise inform the join relevance indicia. In this way, the system involves the user in reinforcement, validation and correction of join recommendations.

Returning to FIG. 3, the next operation is to store metadata 316. For example, data type metadata 208 may be stored in the metadata catalog 166 shown in FIG. 2. The final operation of FIG. 3 is to select a default visualization 318. That is, relying upon one or more of the data type, data shape and data scale, the data ingest module 164 may establish a default visualization (e.g., map, bar chart, pie chart, etc.).

Thus, an embodiment of the invention provides for data ingestion from disparate data sources and data inferences about the ingested data. Inferred data types are derived from structured, semi-structured and/or unstructured data sources. The data source may be internal private data or an external data source. The invention supports ingestion through any delivery mechanism. That is, the source can provide one-time data ingestion, periodic data ingestion at a specified time interval or a continuous data ingestion of streamed content.

The data ingestion process also provides for data harmonization by leveraging identified data types. That is, the identified data types are used to automatically build an ontology of the data. For example, in the case of a recognized zip code, the harmonization process creates a hierarchy from zip code to city to county to state to country. Thus, all data associated with the zip code is automatically rolled up to a city aggregate value, a county aggregate value, a state aggregate value and a country aggregate value. This automated roll-up process supports subsequent drill-down operations from a high hierarchical value to a low hierarchical value (e.g., from state to city). This information is then used to generate the most appropriate visualization for the data. This data harmonization also accelerates the convergence of two or more data sets.

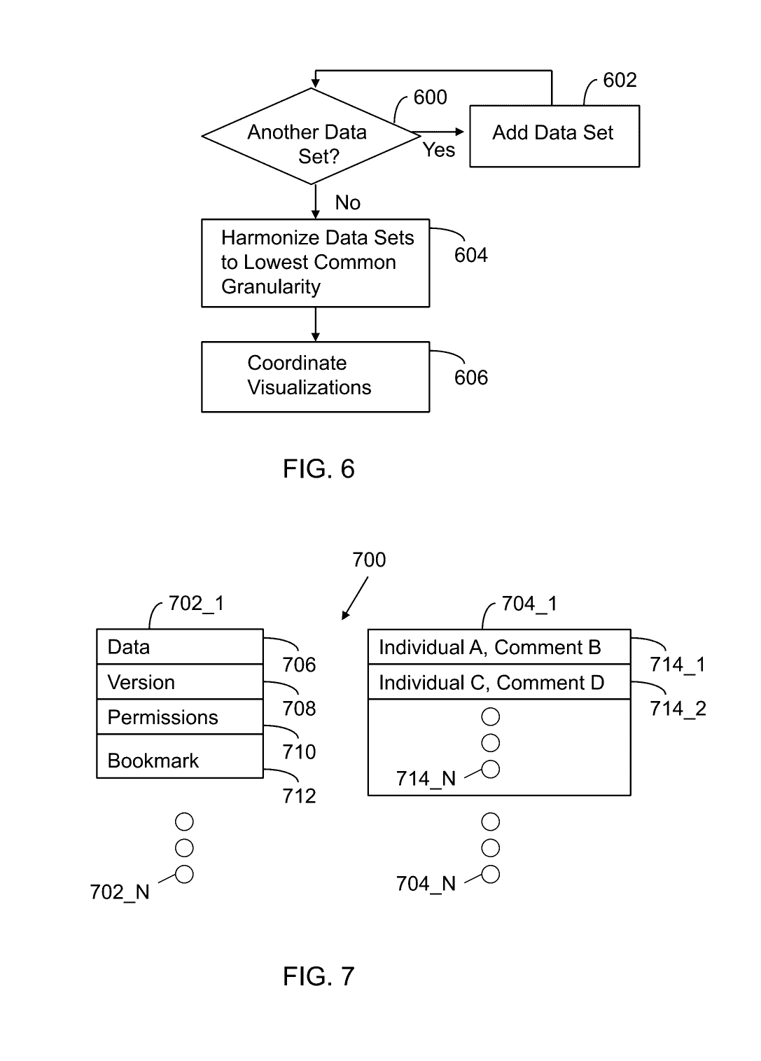

The convergence of two or more data sets may be implemented through the data processing module 170 and the story control module 200 of the web application module 160. FIG. 6 illustrates processing operations associated with the convergence of two or more data sets. A user has an opportunity to select a data set 600. If a dataset is selected (600—Yes), a data set is added 602. After all data sets have been selected, the data sets are harmonized to the lowest common data unit granularity 604. That is, when two or more data sets are converged, the common dimensions across the data sets are harmonized so that the converged data sets get rendered into visualizations that are common elements between the data sets. For instance, if a first data set is at a zip code level and a second data set is at a county level, when the first data set is combined with the second data set, the combination is automatically harmonized to the lowest level of common granularity. In this example, county is the lowest common granularity across the data sets. This harmonization accelerates the process of converging multiple data sets during multi-source analyses. The final operation of FIG. 6 is to coordinate visualizations 606. The visualization may be based upon the granularity of the data set (data scale), the data shape and/or the data type. The system selects a default visualization, which may be overridden by a user. Examples of the foregoing operations are provided below.

The data processing module 170 is an in-memory iterative analytic data processing engine that operates on “data units” associated with a story. FIG. 7 illustrates a story 700 comprising a set of data units 702_1 through 702_N. Each data unit has a corresponding discussion thread 704_1 through 704_N. In one embodiment, a data unit 702 includes data 706. The data 706 includes raw ingested data plus rolled-up hierarchical data, as previously discussed. A data unit also includes a version field 708. The version field may use a temporal identifier to specify a version of data, for example, after it has been filtered during some analytic process. A permissions field 710 specifies permissions to access the data. Different individuals collaborating in connection with a story may have different access levels to the data. For example, one individual may have access to all data, while another individual may only have access to aggregated data. A bookmark field 712 may be used to persist a data unit, as discussed below.

Each discussion thread 704 includes a set of discussion entries 714_1 through 714_N. Permissions field 710 may establish individuals that may participate in a discussion thread. Example discussion threads are provided below.

Thus, FIG. 7 illustrates the in-memory manifestation of a discussion thread and its association with an in-memory data unit 702. Data operators (e.g., sum, average, standard deviation) may be used to perform iterative operations on data units. Each data unit may also store filter information, a best fit data visualization setting, and data visualization highlight information.

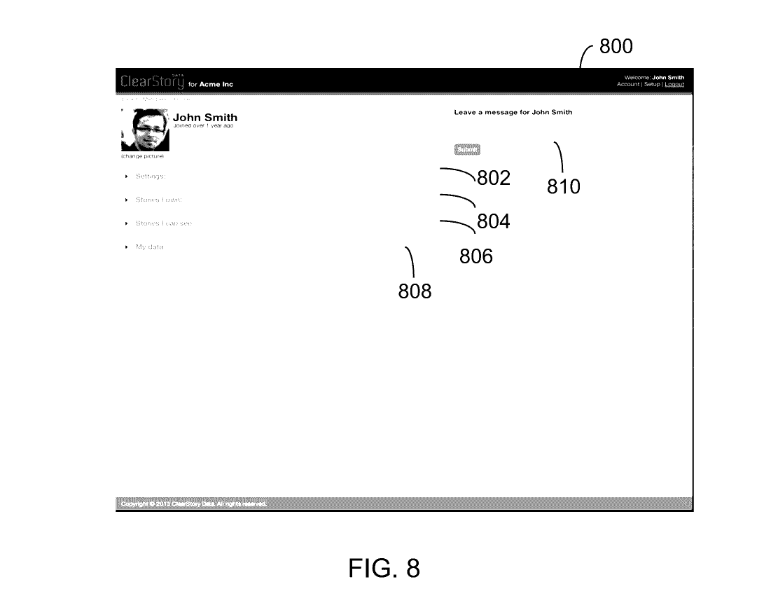

The operations of the invention are more fully appreciated with reference to a use scenario. FIG. 8 illustrates a home page 800 that may be displayed on a browser 122 of a client device 102. The home page 800 may be supplied by the web application module 160. In this example, the home page 800 includes a settings field 802. The home page 800 also includes a field 804 to list stories owned by the user. These are stories constructed by or on behalf of the user. Typically, such stories are fully controlled by the user.

The home page 800 may also include a field 806 for stories that may be viewed by the user. The user may have limited permissions with respect to viewing certain data associated with such stories. In one embodiment, the permissions field 710 of each data unit 702 specifies permissions.

The home page 800 also has field 808 for supplying data owned by a user. The data owned by a user is effectively the data units 702 owned by a user. Finally, the home page 800 includes a collaboration field 810 to facilitate online communication with other users of the system. The discussion threads 704 populate the collaboration field 810.

Thus, all users have settings, data and stories. Access to stories and collaboration permissions may be controlled by the stories metadata 212 and collaboration metadata 214 of the metadata catalog 166 operating in conjunction with the data units. More particularly, the web application module 160 utilizes the story control module 200 to access stories metadata 212 and the collaboration module 202 to access collaboration metadata 214. The web application module 160 may pass information to the data processing module 170, which loads information into data units 702 and discussion threads 704.

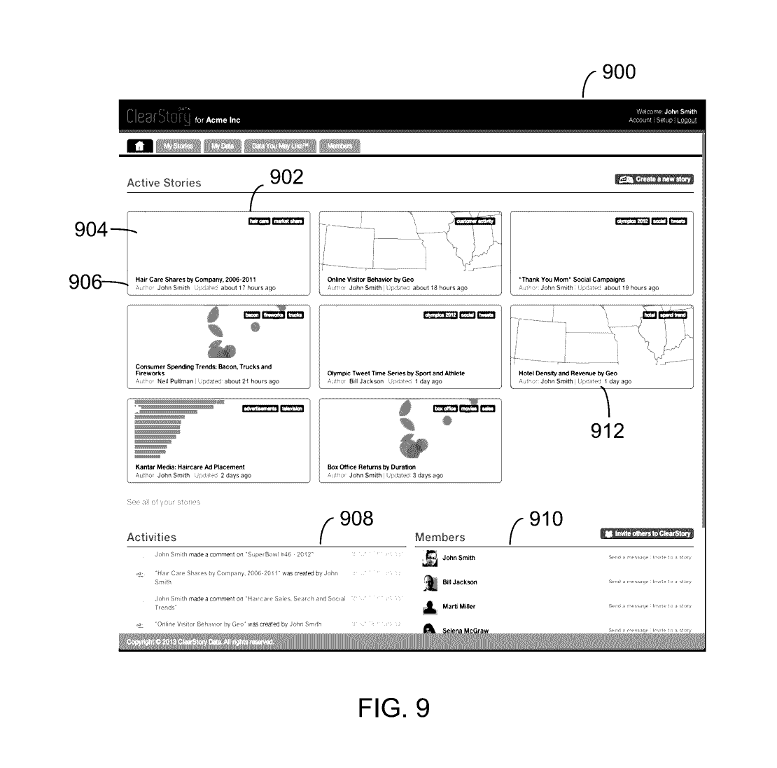

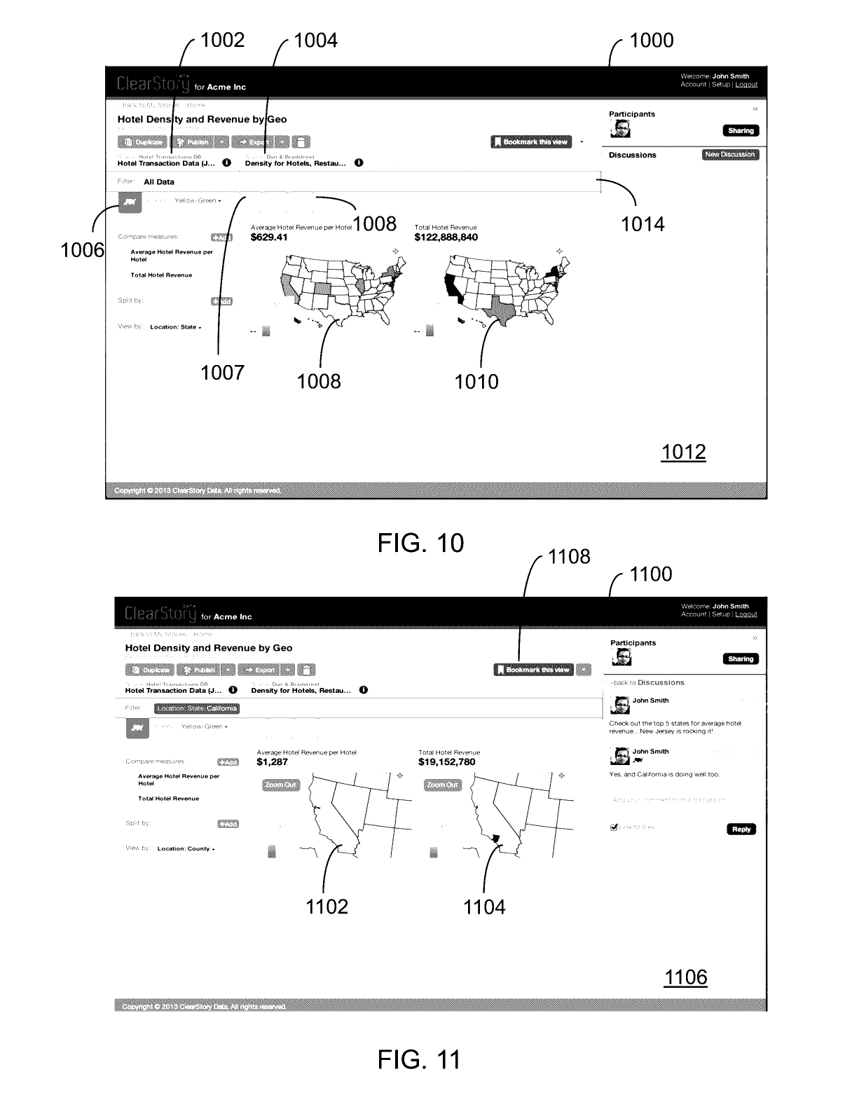

If a user activates the link 804 for her stories, an interface, such as that shown in FIG. 9 may be supplied. FIG. 9 illustrates an interface 900 depicting individual stories 902. Each story 902 may have an associated visualization 904 and text description 906. The interface 900 may also display a text description of recent activities 908 by the user. Collaborative members 910 may also be listed. If the user selects story 912, the interface of FIG. 10 is provided.

FIG. 10 illustrates an interface 1000 for the story entitled “Hotel Density and Revenue by Geography”. The interface 1000 indicates a first data source 1002 from a hotel transaction database and a second data source 1004 from a Dun & Bradstreet report on hotel density. In this example, the hotel transaction database has information organized as a function of time, while the hotel density information is organized by geography. The invention provides a data-aware convergence of these two data sets. More particularly, FIG. 10 illustrates data-aware convergence and visualization of disparate data sources. Observe that in FIG. 9 the story 912 is geographically scaled based upon the amount of screen space available. That is, in FIG. 9, interface 900 simultaneously displays multiple stories. Consequently, the story control module 200 scales the amount of displayed information in a manner consistent with the amount of screen space available. On the other hand, after story 912 is selected, a data-aware visualization transition occurs, with an enhanced amount of information displayed, as shown in interface 1000 of FIG. 10. Since more space is available in interface 1000, the story control module 200 expands the amount of displayed information. As previously discussed, the data type metadata 166 includes information on data types, data shape and data scale for ingested data. This information may be used to select appropriate visualizations.

The interface 1000 provides different visualization options 1006, 1007, 1008, such as a map, bar graph, scatter plot, table, etc. In this example, the map view 1006 is selected. Each visualization option has a set of default parameters based upon an awareness of the data. In this example, average hotel revenue per hotel for an arbitrary period of time is displayed in one panel 1008, while total hotel revenue for the same arbitrary period of time is displayed in another panel 1010. As shown, shading may be used to reflect density of activity.

The interface 1000 also includes a collaboration section 1012. The filter indicator 1014 specifies that all data is being processed. This filter may be modified for a specific geographic location, say California, in which case the interface of FIG. 11 is provided.

FIG. 11 illustrates an interface 1100 with the same data as in FIG. 10, but for a smaller geographic region, namely one state, California. A visualization of average hotel revenue per hotel is provided in one panel 1102, while a visualization of total hotel revenue is provided in another panel 1104. Observe that the visualization transition from interface 1000 to interface 1100 is data-aware in the sense that the visualization supplies data relevant to the specified filter parameter.

The collaboration section 1106 illustrates a dialog regarding the data. A tab 1108 allows one to bookmark this view. That is, activating the tab 110 8 sets the bookmark field 712 in a data unit 702 associated with the story. This view and associated dialog information is then stored in a data unit 702 and corresponding discussion thread 704. In this way, the information can be retrieved at a later time to evaluate the evolution of a story.

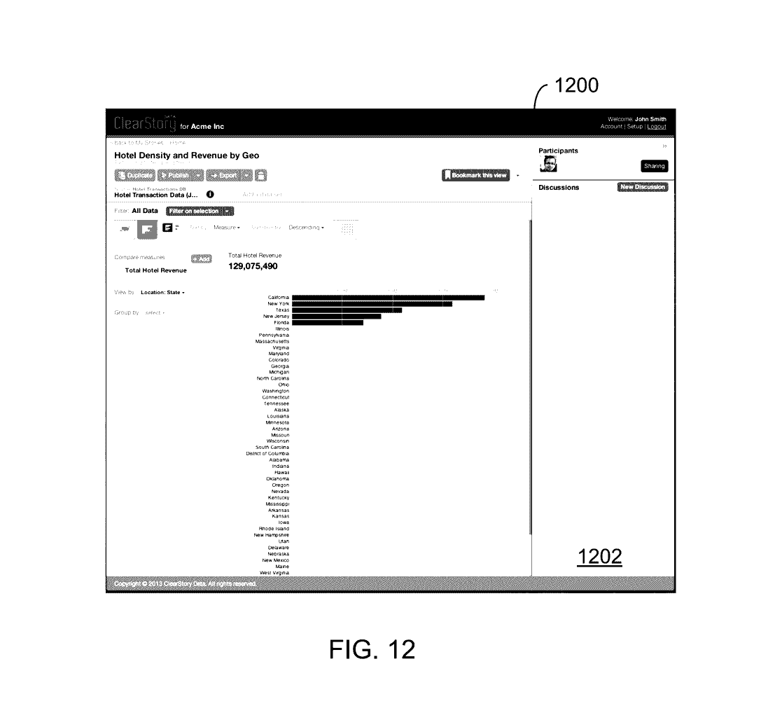

As previously indicated in connection with FIG. 10, different visualization options 1006, 1007 and 1008 are available. If the user selects a bar chart option 1007, then the interface of FIG. 12 is supplied. FIG. 12 illustrates an interface 1200 displaying the total hotel revenue data as a bar chart. Observe here that the filter 1014 is set for all data. Therefore, the transition to the new visualization is for all data. That is, the same data filter is used for the new visualization. Also observe that there is collaboration context awareness as the collaboration section 1012 of FIG. 10 corresponds to the collaboration section 1202 of FIG. 12. A highlight from the visualization of FIG. 10 may carry over to the visualization of FIG. 12. This process is known as highlighting and linking, where a highlight on any one visualization is then linked to every other related visualization. For example, if in FIG. 10, the states California, New York, Texas, New Jersey and Florida are highlighted on the map, those same states are highlighted in the bar graph of FIG. 12.

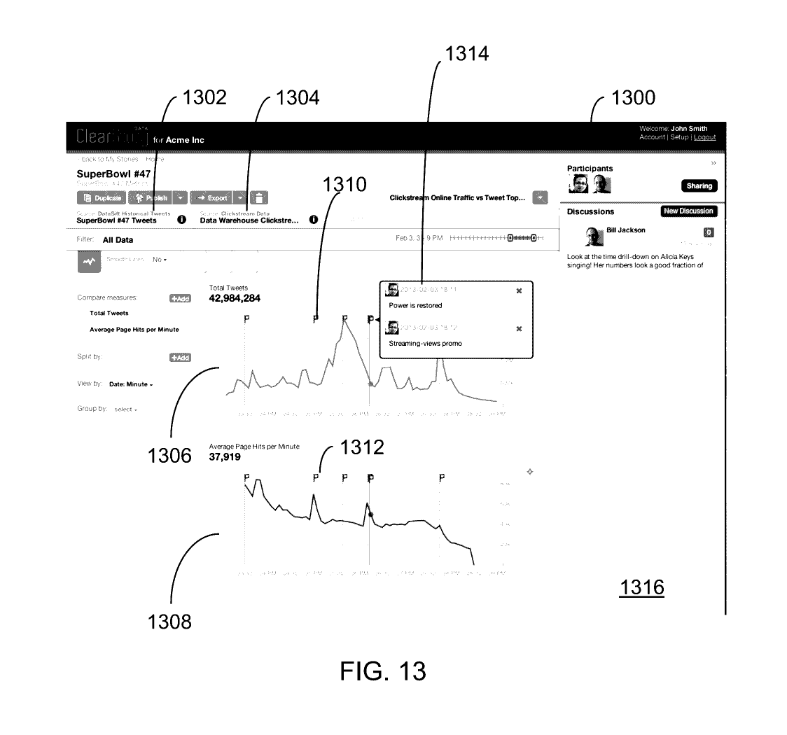

FIG. 13 illustrates an interface 1300 that displays a first data source 1302 of Tweet frequency data during Super Bowl 47. A second data source 1304 is data from a data warehouse of click stream online activity during the same time period. Graph 1306 is for the data from the first data source 1302, while graph 1308 is for the data from the second data source 1304. The time axes for the two graphs 1306 and 1308 are aligned. Similarly, individual annotations on the two data sets are aligned, as shown by annotations 1310 and 1312. Thus, if an annotation is made on one visualization, it is automatically applied to another visualization.

Hovering over an annotation may result in the display 1314 of collaboration data. A separate collaboration space 1316 with a discussion thread may also be provided. The web application module 160 facilitates the display of annotations 1310 and 1312, collaboration data 1314 and collaboration space 1316 through access to the collaboration metadata 214.

Observe that the annotations 1310 are applied to visualized data. Annotations are stateful annotations in a discussion thread 704 associated with a data unit 702. An annotation may have an associated threshold to trigger an alert. For example, one can specify in an annotation a threshold of $10,000 in sales. When the threshold is met, an alert in the form of a message (e.g., an email, text, collaboration panel update) is sent to the user or a group of collaborators. A marker and an indication of the message may be added to the annotations.

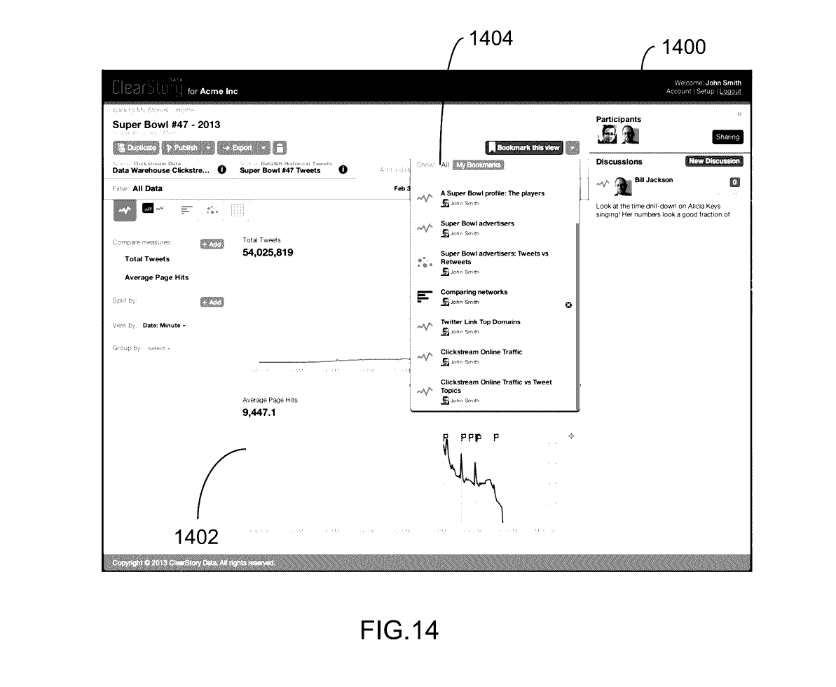

FIG. 14 illustrates an interface 1400 corresponding to interface 1300, but with a different period of time specified on the time axis. As a result, the five annotations shown in graph 1308 are in a condensed form in graph 1402. The figure also illustrates a set of bookmarks 1404 associated with this view of data. The bookmarks 1404 are supplied by the web application module 160 through its access to the collaboration metadata 214.

Thus, the invention provides convergence between multiple data sources, such as public data sources, premium data sources and private data sources. The invention does not require rigid structuring or pre-modeling of the data. Advantageously, the invention provides harmonization across key dimensions, such as geography, time and categories.

In certain embodiments, data is continuously pushed to a user. Consequently, a user does not have to generate a query for refreshed data. In addition, a user can easily collaborate with others to facilitate analyses across distributed teams. Permission settings enforce user policies on viewing and sharing of data and analyses.

Those skilled in the art will appreciate the numerous benefits associated with the disclosed stories. Those benefits may be limited to data analysts and similar power users that are knowledgeable about data sources and interactions with data sources. However, in any enterprise there are numerous decision makers that do not have such expertise. Accordingly, it would be desirable to provide such decision makers with simplified tools that facilitate in-context collaboration with respect to analytical data.

An embodiment of the invention facilitates the creation of what will be referred to as a storyboard. A storyboard is a collection of visualization frames. Typically, the collection of visualization frames characterize a logical sequence of data analytics, although any combination of visualization frames may be used in accordance with embodiments of the invention. Each visualization frame is a snapshot of data. Since a snapshot of data is collected, the creator of the storyboard need not be a data analyst or other sophisticated computer user. As discussed below, permissions and visualization settings simplify storyboard creation and utilization. The permissions may be at the storyboard level and/or individual frame level.

The collection of visualization frames has an associated collection of discussion threads. Each discussion thread involves different users and comments made by the different users. The discussion threads facilitate in-context collaboration of analytical data in the collection of visualization frames.

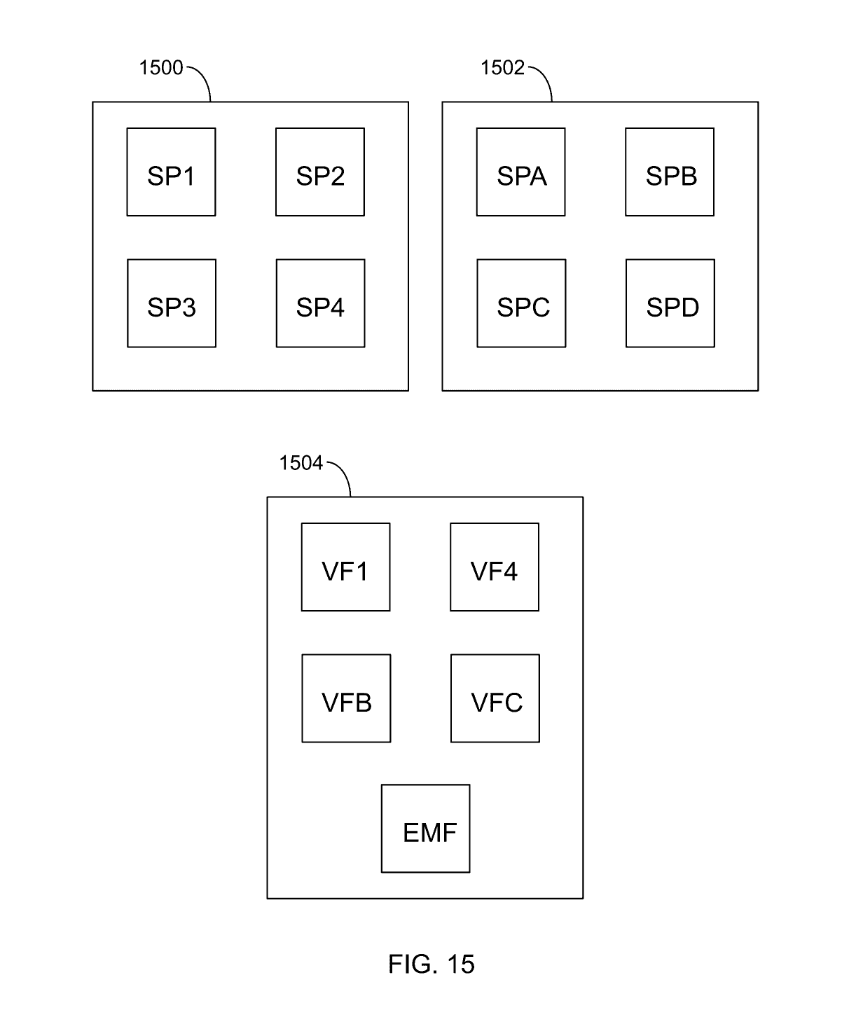

FIG. 15 illustrates a first story 1500 with four story panels SP1, SP2, SP3 and SP4. The figure also illustrates a second story 1502 with four story panels SPA, SPB, SPC and SPD. As discussed below, the web application module 160 is configured to allow a user to collect selected story panels to form a storyboard, such as storyboard 1504. For example, hovering over a story panel may result in a prompt, such as “Move to Storyboard?” Alternately, a user may open a storyboard and receive a prompt to select story panels from different stories.

Storyboard 1504 has a canvas with different visualization frames. In this example visualization frame VF1 corresponds to story panel SP1, visualization frame VF4 corresponds to story panel SP4, visualization frame VFB corresponds to story panel SPB and visualization frame VFC corresponds to story panel SPC. Thus, in this example selected story panels from different stories are used to form storyboard 1504. In this way a compelling data analysis may be constructed through a logical sequence of visualization frames.

The storyboard 1504 may also include a reference to an external media file (EMF). For example, the EMF may be a link to an audio/visual resource that may be played to augment the sequence of data analytics associated with VF1, VF4, VFB and VFC. Thus, it can be appreciated that the data analytic and collaborative aspects of the disclosed technology may be supplemented by additional media sources. The additional media sources may include data visualizations created in other business intelligence tools.

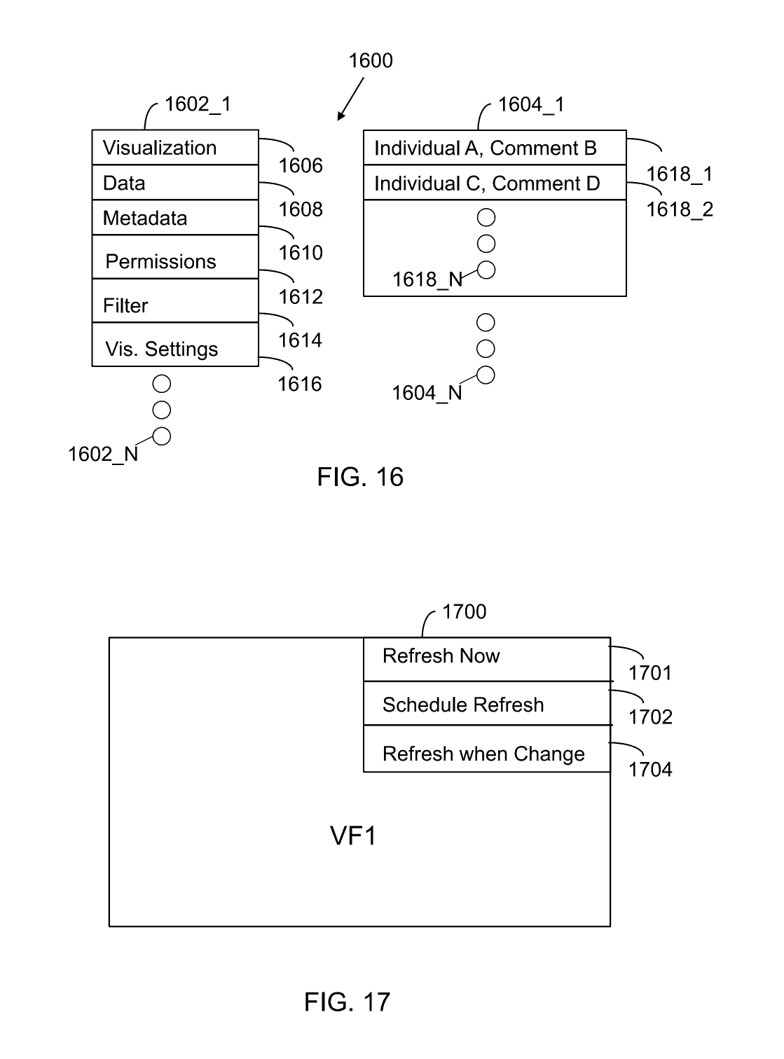

FIG. 16 illustrates a storyboard 1600 comprising a set of visualization units 1602_1 through 1602_N and a collection of discussion threads 1604_1 through 1604_N. A visualization unit is similar to the previously discussed data units. However, each visualization unit is a simplified version of a data unit. The visualization units facilitate the creation and utilization of a collection of visualization frames. The visualization units mask data source complexity and provide automated operations, such as automated refresh of data, which allows the storyboard to be used by enterprise employees that are technically less sophisticated.

In one embodiment, a visualization unit includes a graphical visualization 1606 representing a snapshot of data (i.e., data at a given instance in time). The visualization unit also includes data 1608 associated with the visualization (i.e., the data that is expressed in the visualization). The visualization unit also includes metadata, such as a title for the visualization, a description of the data and the like. Various permissions 1612 are set for the visualization unit. The permissions are based upon the status of the user. For example, the creator of a storyboard may have more permission to manipulate the storyboard than a consumer or viewer of the storyboard.

A visualization unit also includes a filter configuration block 1614. As discussed below, permissions 1612 express the type of filters that one may apply to the data 1608. The sophistication of the available filters is typically a function of the sophistication of the user. The visualization unit may also include visualization settings 1616, such as visualization type (graph, bar, pie, etc.), visualization orientation, visualization scaling and the like.

The story board 1600 also includes a collection of discussion threads 1604_1 through 1604_N. Each discussion thread lists different users and comments made by the different users. For example, entry 1618_1 is a comment B from individual A, while entry 1618_2 is comment D from individual C.

The storyboard and its associated visualization units and discussion threads may be in-memory data structures that facilitate improved functioning of a computer system. For example, the visualization units include automated data access for data refresh on a scheduled basis. The visualization units mask system complexity for a user.

Turning now to FIG. 17, an individual visualization frame, such as VF1, may have an associated data refresh prompt 1700, which includes various data refresh configuration parameters. In this example, the data refresh configuration parameters include data refresh on demand (“Refresh Now”) 1701, a scheduled data refresh 1702 and data refresh based upon a data change 1704. The scheduled refresh 1702 may be based upon any specified time interval (e.g., every 15 minutes, every 30 minutes, every hour, every day, every week, every month, etc.). The data refresh configuration parameter may be stored in the visualization unit, which includes executable instructions to access the source data at the specified interval. Observe that this automated approach insulates the user from the complexities of data access.

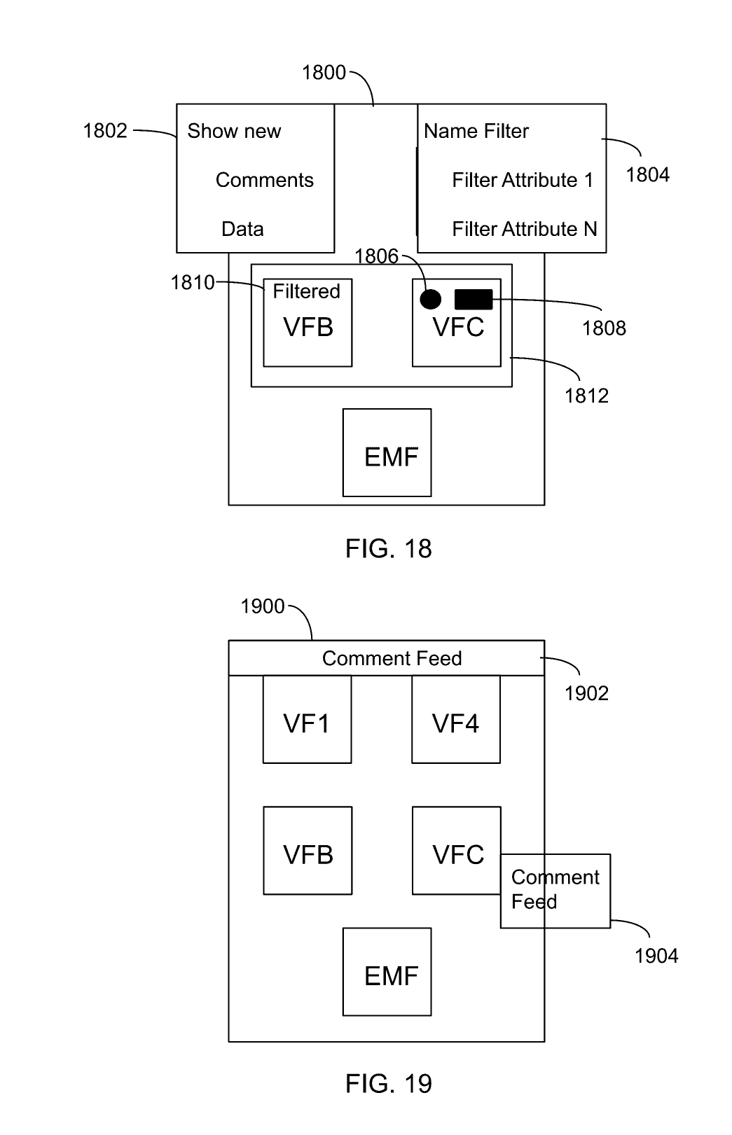

FIG. 18 illustrates a storyboard 1800 with prompts 1802 and 1804. Prompt 1802 allows a user to specify whether to provide an indication of new comments or new data. Indicia 1806 may be used to indicate new comments and indicia 1808 may be used to indicate new data. The indicia may be text, a graphical symbol, an altered font and the like.

Prompt 1804 allows one to specify filter conditions for the snapshot of data. For example, the filter conditions may relate to the granularity of the data (e.g., instead of data for a country, data for a specific state). In one embodiment, a user is prompted to name a filter. The user is then given various pull-down menu options for various filter attributes. The filter attributes may be based upon the permissions associated with the user. A sophisticated user may be given more filter attributes, while an unsophisticated user may be given limited filter attributes. This is another example of how the disclosed technology allows unsophisticated users to successfully work with data sources that may otherwise be inaccessible to the unsophisticated users.

After a filter is set, the filter condition is applied to each visualization frame that has data corresponding to the filter. Indicia 1810 may be used to let the user know which visualizations have been filtered.

FIG. 18 also illustrates a visualization frame section 1812. Such frame sections 1812 may be used to segregate related data analytics. This can reduce the complexity of a story board with numerous visualization frames.

FIG. 19 illustrates a storyboard 1900 with a comment feed 1902 associated with the entire storyboard 1900. In one embodiment, the comment feed 1902 is a scroll of discussion threads that may be stopped, started, rewound, etc. Alternately or in addition, a comment feed 1904 may be associated with a specific visualization frame. In one embodiment, the comment feed 1904 includes links to external media. Individual comments or text entries may be associated with individual data elements in the visualization frame. For example, an individual comment may relate to a section of a pie chart or two sections of a pie chart. Interface tools are supplied to allow a user to select individual data elements and groups of data elements which are then linked to a text entry regarding the selected data. The data elements may be contiguous or non-contiguous.

In one embodiment a discussion thread includes automatically generated text entries that are produced in response to a data value exceeding a specified threshold. For example, a rule may be specified that if a dollar value exceeds a specified threshold, then a comment, such as, “Sales target exceeded” may be automatically inserted into the discussion thread. Thus, the discussion thread may include input from users and rule based input that is automatically generated by the system. The automatically generated text may be accompanied by an alert sent to a user, for example an email alert sent to a user. The automatically generated text may also be accompanied by indicia placed in the visualization (e.g., indicia in a visualization of sales volume of where the sales target is exceeded). The automatically generated text may be a link to an external resource, such as the original business plan expressing the sales target.

Once a storyboard is constructed, it may be used as a template that facilitates substitution of a first set of data sources with a second set of data sources to produce a new collection of visualization frames. For example, hovering over a visualization frame may result in a prompt “Specify new data source?” A user may then enter the new data source or may be alternately provided with a pulldown menu of data sources available to the user.

In one embodiment, indicia (e.g., a pin) is used to show related data in different frames of a storyboard. For example, one my hover over a data element and receive a prompt to move to another frame with the same data element. In a similar way, one may be prompted to see recent collaboration across a set of visualization frames.

A prompt may also be supplied to export a storyboard to a different file format. For example, a file format for offline processing may be used, such as a PDF format and PowerPoint® format and the like.

In one embodiment, a storyboard provides an option to link back to a story associated with a visualization frame. For example, hovering over a visualization frame may result in a prompt “Transition to original story?” A transition to the original story may then be implemented, which allows the user to collaborate in the original story, for example, by requesting clarification about a data element.

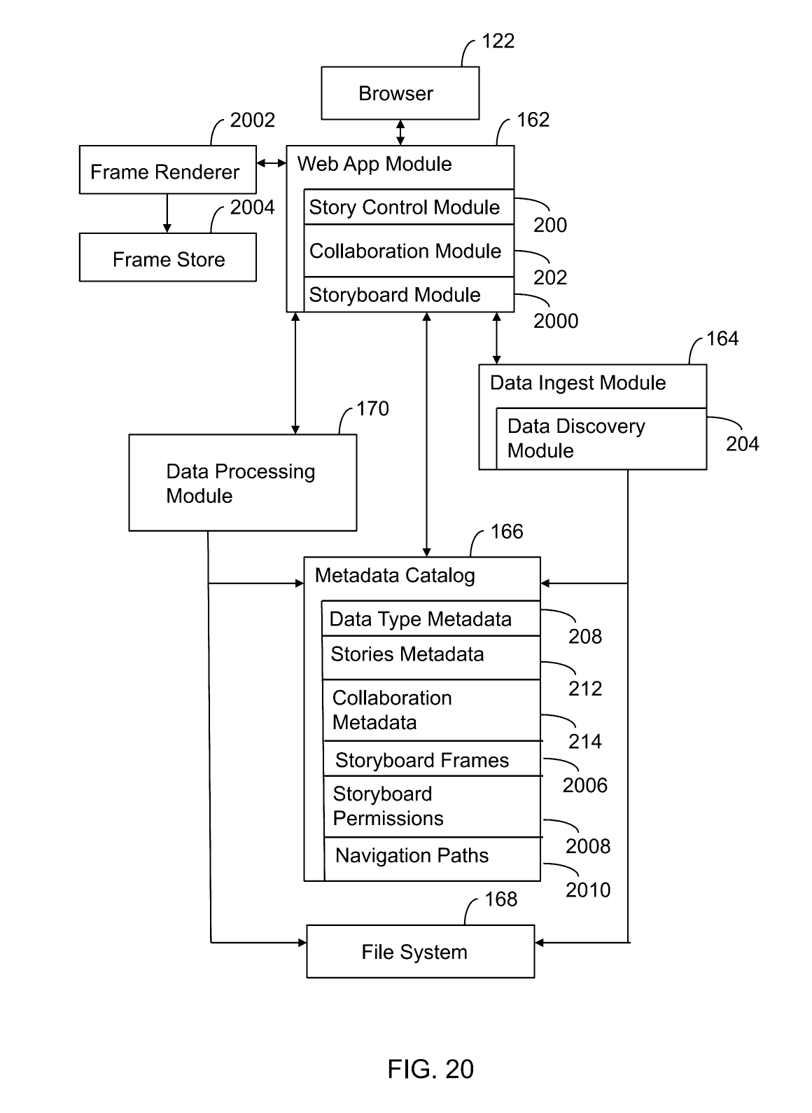

FIG. 20 illustrates architectural components utilized to implemented the disclosed storyboards. Many components correspond to components already discussed in connection with FIG. 2. The current discussion is limited to a discussion of the new components 2000-2008. The web application module 162 is augmented to include a storyboard module 2000. The storyboard module 2000 includes executable instructions to populate browser 122 with interfaces of the type disclosed above. In addition, the storyboard module 2000 interacts with a frame renderer 2002. The frame renderer 2002 is configured to take a data snapshot. For example, consider the case where a story is rendered in browser 122. A prompt may be provided to the user to move the story to a storyboard. If the user engages the prompt, the frame renderer 2002 produces a visualization unit 1602 and persistently stores the frame in a frame store 2004.

The storyboard module 2000 interacts with the frame renderer 2002 to update the metadata catalog 166 to create storyboard frames 2006. That is, the metadata catalog 166 is supplemented with metadata associated with each frame and the storyboard in which it resides. In addition, the metadata catalog 166 may store storyboard permissions 2008. The storyboard permissions may control permissions at the storyboard level. The permissions may be of the type discussed in connection with the visualization units. Thus, embodiments of the invention express permissions at the visualization unit level and/or the storyboard level. In one embodiment, a scheduler (not shown) operates with the web application module 162 and the frame renderer 2002 to schedule the rendering of frames in accordance with a refresh schedule discussed in connection with FIG. 17.

Another aspect of the system is state based visual data link recommendations. The metadata catalog 166 maintains a set of navigation paths 2010. Each navigation path specifies a user and navigation path parameters representative of data exploration performed by the user. The navigation path parameters may include data set used, dimension in the data set used, filters applied to the data set and data elements selected. The navigation path is maintained for each user session by the storyboard module 2000. The full navigation path or parts of it may be associated with comments stored in the metadata catalog 166. Thus, a navigation path may have an associated set of comments to give a user an understanding of how the navigation path was evaluated.

The web application module 162 includes executable instructions to access the navigation paths. Further, the web application module 162 accesses the storyboard module 2000 and the frame store 2004, via the frame renderer 2002, to evaluate the collection of parameterized visualizations available in the system. The collection of parameterized visualizations includes visualization frames and story boards. Each parameterized visualization includes at least one parameter selected from a data set parameter, a data set dimension, and a data set filter. Each parameterized visualization may have multiple data set parameters, multiple data set dimensions and multiple data set filters. Each parameterized visualization may also include a visualization rank indicative of the popularity of the visualization. Further, each parameterized visualization may include data access permissions. A user may also navigate to a frame that is ranked on criteria other than parameterized criteria.

A recommendation for a new visualization is supplied based upon the user navigation path. More particularly, the recommendation is supplied by the web application module 162 and/or the data processing module 170 based upon a comparison of the navigation path to the collection of parameterized visualizations. The supplied visualization recommendation may be one of several ranked recommendations for new visualizations presented in a pull-down menu rendered in browser 122.

The web application module 162 and/or data processing module 170 compares parameters of a navigation path to parameters in the collection of parameterized visualizations. Matches between data sets used in both the navigation path and the parameterized visualizations are sought. Further, matches between dimensions used in a navigation path and corresponding dimensions in the collection of parameterized visualizations are sought. Similarly, corresponding filters in both the navigation path and the parameterized visualizations are identified. The higher the correspondence between the navigation path parameters and corresponding parameters of a parameterized visualization, the higher the rank associated with a given parameterized visualization. The rank may also factor in the visualization rank for the parameterized visualization, with a high visualization rank being weighted accordingly. Data access permissions may also be evaluated in the ranking process. If a particular user has restricted data access to a particular parameterized visualization, this may result in a lower rank for the particular parameterized visualization or the removal of the particular parameterized visualization as a candidate. Non-parameterized visualizations may also be suggested to the user. For example, the same data set with different visualization settings may be suggested.

A new visualization selection is accepted (e.g., through a pull-down menu selection in browser 122) and a new visualization is rendered based upon the selection. The frame renderer 2002 renders the new visualization in conjunction with the web application module 162. The new visualization is rendered with data corresponding to data specified in the user navigation path. More particularly, the new visualization is rendered at a data granularity level corresponding to the data granularity level in the user navigation path. Thus, a user is supplied with a new visualization for a data set that the user has already accessed and is therefore familiar with. The new visualization may be a visualization frame or a story board.

The new visualization may include a discussion thread from a data granularity level specified in a navigation path of a prior visualization, which is applied to the new visualization at the corresponding data granularity level. For example, if there was a discussion thread about sales activity at a particular store in a chain of stores, a new visualization related to the sales activity at the particular store would include the prior discussion thread. On the other hand, if the new visualization related to sales activity for the chain of stores across the country, such a discussion thread may be omitted.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A server, comprising:
a data processing module with instructions executed by a processor to:
maintain a collection of visualization frames that characterize a sequence of data analytics, wherein each visualization frame is a snapshot of data and the collection of visualization frames has associated permissions and visualization settings;
maintain a user navigation path through the collection of visualization frames, wherein the navigation path specifies a data set used and a dimension accessed in the data set; and
supply a recommendation for a new visualization based upon the user navigation path.

2. The server of claim 1 wherein the navigation path specifies a filter used.

3. The server of claim 1 wherein the navigation path specifies a data element selected.

4. The server of claim 1 further comprising a collection of parameterized visualizations, wherein each parameterized visualization includes a data set parameter, a dimension parameter and a filter parameter.

5. The server of claim 4 wherein each parameterized visualization includes a visualization rank and data access permissions.

6. The server of claim 4 wherein the instructions executed by the processor to supply a recommendation for a new visualization is based upon a comparison of the navigation path to the collection of parameterized visualizations.

7. The server of claim 1 further comprising instructions executed by the processor to accept a new visualization selection and render a new visualization based upon the new visualization selection.

8. The server of claim 7 wherein the instructions executed by the processor to render the new visualization render the new visualization with data corresponding to data specified in the user navigation path.

9. The server of claim 1 wherein the visualization is a visualization frame.

10. The server of claim 1 wherein the visualization is a story board.

11. The server of claim 1 further comprising instructions executed by the processor to maintain a collection of discussion threads for the collection of visualization frames, wherein each discussion thread identifies different users and comments made by the different users.

12. The server of claim 11 further comprising instructions executed by the processor to accept a new visualization selection and render a new visualization based upon the new visualization selection, wherein the new visualization includes a discussion thread from a data granularity level in a prior visualization that is applied to the new visualization at the corresponding data granularity level.

13. The server of claim 11 further comprising instructions executed by the processor to maintain comments associated with the user navigation path.
